(19) United States
(12) Patent Application Publication
(10) Pub. No.: US 2023/0169305 A1
(43) Pub. Date: Jun. 1, 2023

(54) ORGANIZING SEQUENCES FOR TRANSFORMER COMPUTE

(71) Applicant: International Business Machines Corporation, Armonk, NY (US)

(72) Inventors: Geoffrey Burr, Cupertino, CA (US); HsinYu Tsai, San Jose, CA (US); Shubham Jain, Elmsford, NY (US)

(21) Appl. No.: 17/538,989

(22) Filed: Nov. 30, 2021

(51) Int. Cl. G06N 3/04; G06F 17/16; G06N 3/08

(52) U.S. Cl. CPC G06N 3/04; G06F 17/16; G06N 3/08

(57) ABSTRACT

A computer-implemented method according to one embodiment includes determining a threshold sequence-size for a transformer; organizing a batch of sequences according to the threshold sequence-size; and inputting the organized batch of sequences into the transformer.

### BACKGROUND

The present invention relates to machine learning, and more particularly, this invention relates to improving the performance of a hardware transformer.

Deep learning models such as transformers are often used to perform natural language processing (NLP) actions such as text prediction, text translation, text summarization, etc. However, transformers often suffer from performance issues, and current methods to address these issues are resource intensive. There is therefore a need for an improved approach to transformer performance enhancement.

### BRIEF SUMMARY

A computer-implemented method according to one embodiment includes determining a threshold sequence-size for a transformer; organizing a batch of sequences according to the threshold sequence-size; and inputting the organized batch of sequences into the transformer.

According to another embodiment, a computer program product includes one or more computer readable storage media, and program instructions collectively stored on the one or more computer readable storage media, the program instructions including instructions configured to cause one or more processors to perform a method including determining, by the one or more processors, a threshold sequence-size for a transformer; organizing, by the one or more processors, a batch of sequences according to the threshold sequence-size; and inputting, by the one or more processors, the organized batch of sequences into the transformer.

According to another embodiment, a system includes a processor; and logic integrated with the processor, executable by the processor, or integrated with and executable by the processor, where the logic is configured to determine a threshold sequence-size for a transformer; organize a batch of sequences according to the threshold sequence-size; and input the organized batch of sequences into the transformer.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment, in accordance with one embodiment of the present invention.

FIG. 2 depicts abstraction model layers, in accordance with one embodiment of the present invention.

FIG. 3 depicts a cloud computing node, in accordance with one embodiment of the present invention.

FIG. 4 illustrates a flowchart of a method for organizing sequences for transformer compute, in accordance with one embodiment of the present invention.

FIG. 5 illustrates an exemplary transformer environment, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of organizing sequences for transformer compute.

In one general embodiment, a computer-implemented method includes determining a threshold sequence-size for a transformer; organizing a batch of sequences according to the threshold sequence-size; and inputting the organized batch of sequences into the transformer.

In another general embodiment, a computer program product includes one or more computer readable storage media, and program instructions collectively stored on the one or more computer readable storage media, the program instructions including instructions configured to cause one or more processors to perform a method including determining, by the one or more processors, a threshold sequence-size for a transformer; organizing, by the one or more processors, a batch of sequences according to the threshold sequence-size; and inputting, by the one or more processors, the organized batch of sequences into the transformer.

In another general embodiment, a system includes a processor; and logic integrated with the processor, executable by the processor, or integrated with and executable by the processor, where the logic is configured to determine a threshold sequence-size for a transformer; organize a batch of sequences according to the threshold sequence-size; and input the organized batch of sequences into the transformer.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

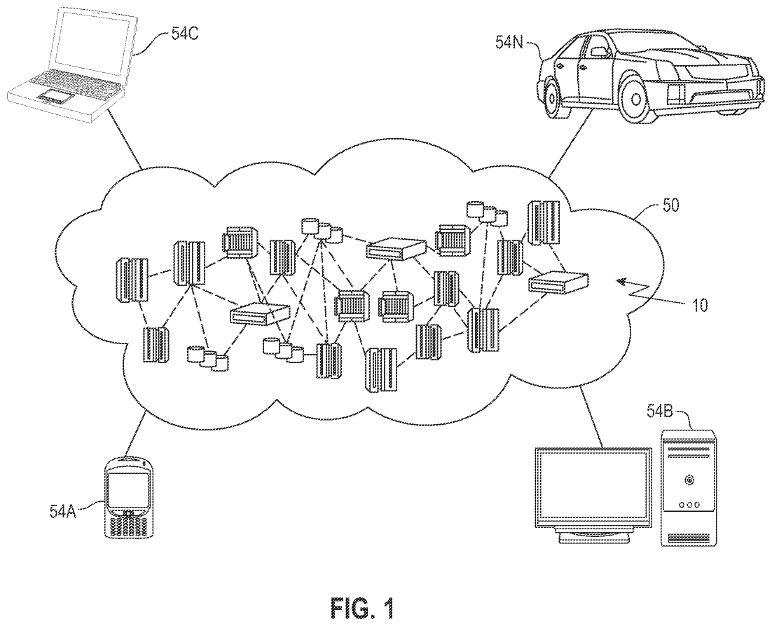

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

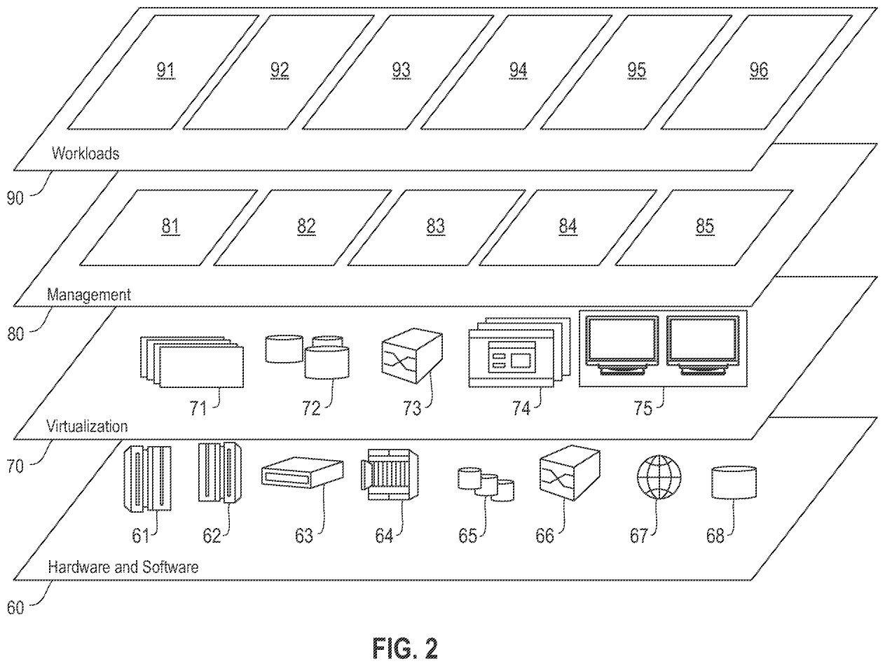

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and natural language processing 96.

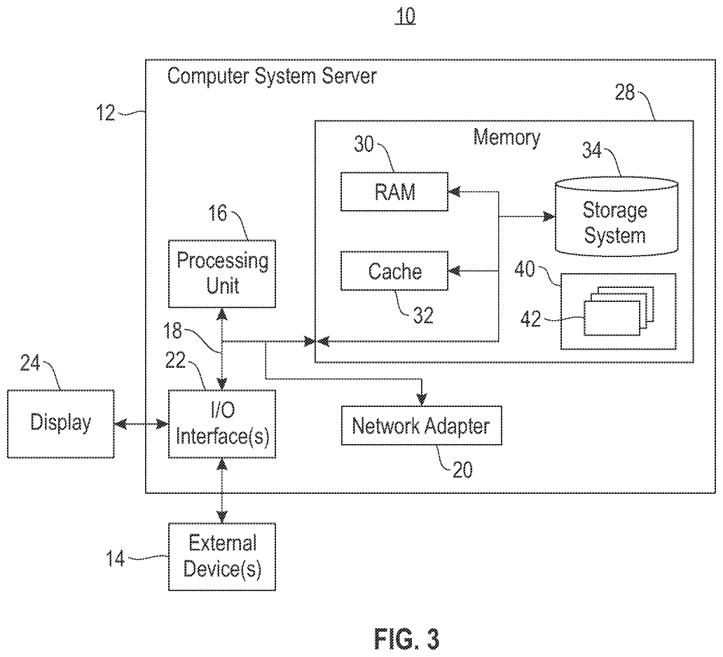

Referring now to FIG. 3, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

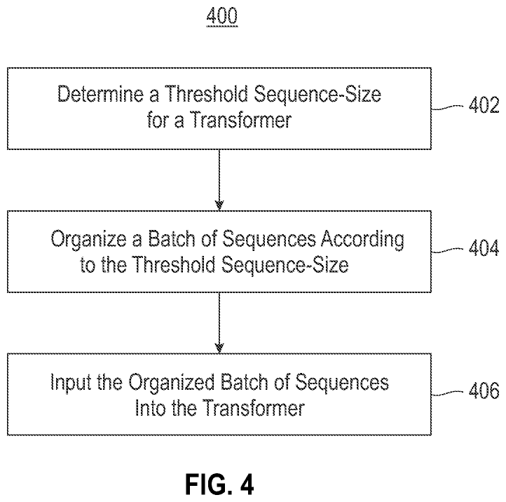

Now referring to FIG. 4, a flowchart of a method 400 is shown according to one embodiment. The method 400 may be performed in accordance with the present invention in any of the environments depicted in FIGS. 1-3 and 5, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by one or more servers, computers, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4, method 400 may initiate with operation 402, where a threshold sequence-size is determined for a transformer. In one embodiment, a transformer may include a deep learning/machine learning model that utilizes an attention mechanism to differentially weigh a significance of each part of input sequences to perform one or more actions (e.g., text prediction, text translation, text summarization, etc.). In another embodiment, the transformer may include a Bidirectional Encoder Representations from Transformers (BERT) transformer. In yet another embodiment, the transformer may include a Generative Pre-trained Transformer (GPT).

Additionally, in one embodiment, the transformer may be used to perform artificial intelligence (AI) hardware acceleration, natural language processing (NLP), etc. In another embodiment, the transformer may include one or more vector matrix multipliers (VMMs). For example, each VMM may include a machine learning block performing vector-matrix multiplication. In another example, excitation vectors input into the VMM may be multiplied by trained-weight matrices within the VMM.

Further, in one embodiment, the transformer may include one or more attention-compute blocks. For example, each attention compute block may perform matrix-matrix multiplication between an excitation vector output from a VMM block. In another embodiment, the transformer may include multiple layers, where each layer includes one or more blocks of VMM in combination with blocks of attention-compute, potentially with residual connections that skip blocks.

For example, the block of VMM may receive excitation vectors as input, may perform a multiplication of the input excitation vectors by trained weight matrices, and may output one or more excitation vectors. In another example, each block of attention-compute may perform matrix multiplication between the output excitation vectors and one or more VMM blocks.

Further still, in one embodiment, the transformer may be implemented utilizing one or more hardware computing components. In another embodiment, a sequence may include a series of tokens (e.g., words, characters, phonemes, images, regions-of-interest from within an image, etc.). In yet another embodiment, the sequence may include a sentence, paragraph, or other text sample for which NLP is to be performed. The sequence-size indicates the length of a sequence (in units of tokens) that is input into the transformer. In some embodiments, the sequence-size may change during the network, as tokens are potentially “stacked” or combined together, or broken apart and duplicated, which may change the sequence-size as the workload proceeds through a multi-layer network.

Also, in one embodiment, the sequence-size of the input sequence determines a first compute time for the sequence for each of one or more vector matrix multipliers (VMMs) of the transformer, representing the time required by the one or more VMMS to compute the input sequence. In one embodiment, the time required for each VMM may scale linearly with the sequence-size.

In a similar manner, the sequence-size of the input sequence determines a second compute time for the sequence by each of one or more attention-compute blocks of the transformer, representing the taken by the one or more attention-compute blocks to compute the input sequence. In one embodiment, the time required for each attention-compute block may scale quadratically with the sequence-size.

When the scaling of the first compute time and second time with the sequence-size are different, there is a threshold sequence-size for which the first compute time has a regular and known relationship with the second compute time. For example, a threshold sequence-size may be determined for the transformer where the first compute time has a known relationship with second compute time (e.g., when the first compute time equals the second compute time, when the first compute time is longer or shorter than the second compute time by a predetermined length, when the first compute time is longer or shorter than the second compute time by a predetermined factor, etc.). This threshold sequence-size will depend on the entire equation for the first and second compute times, including the scaling with sequence-size, any pre-factors affecting these scaling factors, and any constant pre-factors within these compute times that are independent of sequence-size. For example, when the first compute time scales as A*S*S+B*S+C and the second compute time scales as D*S*S+E*S*S+F, where S represents sequence-size, then the threshold sequence-size is affected by the size of A, B, C, D, E and F. Higher scaling rates (proportional to S*S*S or to sqrt(S)) will introduce additional pre-factors.

Furthermore, method 400 may proceed with operation 404, where a batch of sequences is organized according to the threshold sequence-size. In one embodiment, a batch of sequences may include a plurality of sequences to be input into the transformer (e.g., a batch of sentences for which NLP is to be performed, etc.). In another embodiment, organizing the batch of sequences may include identifying a length of each sequence of the batch of sequences (in bytes).

Further still, in one embodiment, organizing the batch of sequences may include comparing the length of each sequence of the batch of sequences to the threshold sequence-size. For example, sequences within the batch of sequences having a sequence length greater than the threshold sequence-size may be added to a first group, marked utilizing first metadata, etc. In another example, sequences within the batch of sequences having a sequence length less than the threshold sequence-size may be added to a second group, marked utilizing second metadata, etc. In a further embodiment, the sequences within each group may be sorted in terms of absolute distance between the threshold sequence-size and each sequence-size. For example, said sorting may result in sequences at the front end of each group that have a small difference between their sequence-size and the threshold sequence-size, while sequences at the back end of each group have large differences between their sequence-size and the threshold sequence-size.

Also, in one embodiment, organizing the batch of sequences may include arranging the sequences within the batch of sequences in an alternating order based on the comparison. In another embodiment, the organized batch of sequences may be arranged such that a sequence from the first group is always followed by a sequence from the second group. In yet another embodiment, the organized batch of sequences may be arranged such that a sequence from the second group is always followed by a sequence from the first group.

In this way, sequences within the organized batch of sequences may alternate between a sequence having a sequence length greater than the threshold sequence-size and a sequence having a sequence length less than the threshold sequence-size.

Additionally, method 400 may proceed with operation 406, where the organized batch of sequences is input into the transformer. In one embodiment, the batch of sequences may be input into the transformer in the alternating order determined utilizing the threshold sequence-size. In another embodiment, the transformer may perform one or more actions (e.g., NLP, etc.) on each of the input sequences. In yet another embodiment, the transformer may provide output (e.g., a translation, text prediction, a summarization, an analysis, a suggested response, etc.) for each of the input sequences.

Further, in one embodiment, given an input sequence having a sequence length greater than the threshold sequence-size, a VMM of the transformer may complete its computations on the input sequence before an associated attention compute of the transformer completes its computations on the input sequence. In another embodiment, given an input sequence having a sequence length less than the threshold sequence-size, a VMM of the transformer may complete its computations on the input sequence after an associated attention compute of the transformer completes its computations on the input sequence.

Therefore, by following input sequences having a sequence length greater than the threshold sequence-size with input sequences having a sequence length less than the threshold sequence-size as input to the transformer, attention computes of the transformer may be provided with additional time to complete more time-consuming computation work within the transformer, thereby eliminating potential pipeline stalls within the transformer where a VMM of the transformer is waiting for an associated attention compute of the transformer to complete.

In this way, pipeline stalls may be minimized within the transformer while operations are being performed on the organized batch of sequences within the transformer. This may improve a performance of one or more hardware computing components implementing the transformer.

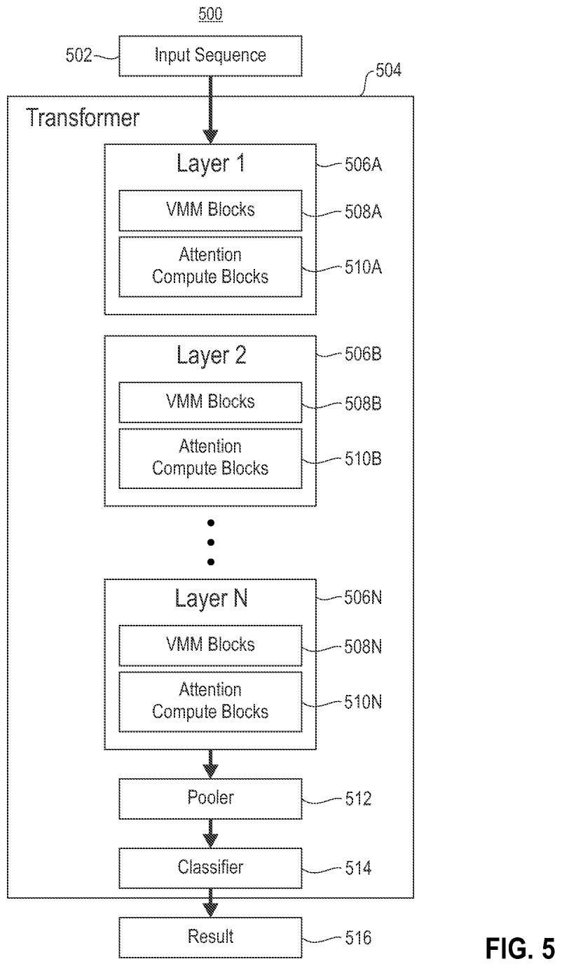

FIG. 5 illustrates an exemplary transformer environment 500, according to one exemplary embodiment. As shown, an input sequence 502 is provided as input to the transformer 504. For example, the input sequence 502 may include a sentence for which NLP is to be performed.

Additionally, in response to receiving the input sequence 502 as input to the transformer 504, the input sequence 502 is processed through each of a plurality of layers 506A-N of the transformer 504. Each of the layers 506A-N includes a plurality of VMM blocks 508A-N interspersed between a plurality of attention-compute blocks 510A-N. The VMM blocks 508A-N may receive excitation vectors as input, may perform a multiplication of the input excitation vectors by trained weight matrices, and may output one or more excitation vectors. Each of the attention-compute blocks 510A-N may perform matrix multiplication between the output excitation vectors and one or more VMM blocks.

Further, after the input sequence 502 is processed by each of a plurality of layers 506A-N, the output is sent to a pooler 512 to reduce output size, and is finally sent to a fully-connected classifier layer 514 where one or more classification operations are performed to create the output result 516 (e.g., a text prediction, a text translation, a text summarization, etc.).

In one embodiment, a plurality of input sequences may be organized according to a threshold sequence-size before being input into the transformer 504 in order to minimize pipeline stalls within the transformer 504 and improve a performance of the transformer 504.

Efficient Batch Sorting for Transformer Compute

Transformers (e.g., BERT, GPT-3, etc.) may include multiple often-identical layers, each comprising blocks of vector-matrix multiply (VMM) (where input excitation vectors are multiplied by trained-weight matrices), interspersed with blocks of attention compute calling for matrix-matrix multiplication between the output excitation vectors from the VMM blocks. The workload may be arranged into sequences of tokens (words or characters) of length S.

The number of compute operations in the attention-compute tends to scale as S², and this block of the workload may typically be staged—for example, all of the input data needed to initiate the attention-compute block may need to be available before the computation starts (otherwise, the computation will rapidly stall). In contrast, the preceding and following VMM blocks may be highly pipelined, and each set of VMM operations may be performed as soon as the input excitation vector is available. These blocks have a number of compute operations that scale linearly with S.

One approach for digital accelerators is to create a large batch of M sequences which will be computed together. However, when the original workload contains sequences of different original length S, this requires a common compute framework based on some S′>max_all(S). These additional zero operations may be wasteful, even if specialized circuitry to detect zero excitations is available.

Another approach is to use very small batch sizes (e.g., where M<8, etc.) and successively pipeline work within the batch from one batch to the next while doing only the necessary computations. This is still relatively efficient even for digital accelerators, since there is reuse of trained weights across the members of the sequence, and the lack of reuse within the attention compute was independent of batch-size anyway.

However, when the size of S varies across the batch, then the linear scaling of the VMM compute in S and the quadratic scaling of the attention compute (proportional to S²) may create frequent pipeline stalls, making it difficult to keep all compute elements busy all of the time, and also making it difficult to have predictable gaps during which compute elements could be efficiently power-gated.

Thus, there is a need in the art for a way to stage the work such that compute elements can be used efficiently.

This invention describes a way to organize a batch of size M of sequences for submission to an AI hardware accelerator performing transformer operations in such a way that the attention compute is continuously busy and the VMM compute can be efficiently power-gated. The advantage of this approach is that internal compute units are kept occupied for a larger fraction of the time, with fewer pipeline stalls, and lower total latency.

In one embodiment, the batch of size M that is ready for submission is organized in sequence order in terms of minimum distance between the sequence-size of each batch member, S, and the sequence-size, S_{b}, for which the compute time for the sequence to pass through each VMM block is identical to the time for the sequence to pass through each attention-compute block. If the batch were completely comprised of sequences of size S_{b}, each block would remain busy all of the time. By building the block by introducing sequences that successively fall below or above S_{b}, compute units can be kept busy close to all of the time. During a sequence of size S>S_{b}, the linear scaling of the VMM block implies that it will finish its work before the attention compute. However, if the next member of the batch is a sequence of size S<S_{b}, then during the computation of this batch, there is less work for the attention compute to perform and it can catch up with the VMM blocks before and after it.

In one embodiment of an analog-AI HW accelerator, while the work to be submitted to the accelerator may be organized into a batch of size M, the weight-stationary nature of the accelerator implies that within the accelerator, compute-units working on the batch can be dealing as few as two local batch members at any instant. From the perspective of the local compute-units, the workload presents itself as a continuous stream of M=2, with each sequence passing through the accelerator in a weight-stationary manner, overlapping at each compute-unit only with the sequence immediately preceding it and the sequence immediately following it.

However, this approach of organizing the batch in preferred order of sequence lengths with respect to a pivotal batch size of size S_{b} is applicable to general digital AI HW accelerators (given an appropriate pipelining strategy), to any compute unit capable of efficiently dealing with sequences or workloads of varying S, and to any neural network where the internal pipelined workload contains successive blocks with a number of operations that scale differently as a function of sequence-size S or any other metric that varies from one member of a batch to the next.

In one embodiment, stalls in attention compute components are minimized by organizing an input workload from long sentences to short sentences. In another embodiment, a total time to process a batch is minimized by organizing the workload in a way that alternates between long sentences and short sentences.

In another embodiment, efficient batch sorting for an analog AI HW accelerator transformer compute may include organizing a batch of size M of sequences for submission to an AI hardware accelerator performing transformer operations in such a way that the attention compute is continuously busy and the vector-matrix multiply (VMM) compute can be efficiently power-gated.

In one embodiment, the batch of size M that is ready for submission is organized in sequence order in terms of minimum distance between the sequence-size of each batch member, S, and the sequence-size, S_{b}, for which the compute time for the sequence to pass through each VMM block is the same as the time for the sequence to pass through each attention-compute block, while the work to be submitted to the accelerator may be organized into a batch of size M, the weight-stationary nature of the accelerator implies that within the accelerator, compute-units working on the batch can be dealing as few as two local batch members at any instant, such that from the perspective of the local compute-units, the workload presents itself as a continuous stream of M=2, with each sequence passing through the accelerator in a weight-stationary manner, overlapping at each compute-unit only with the sequence immediately preceding it and the sequence immediately following it.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement embodiments of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining a threshold sequence-size for a transformer;
organizing a batch of sequences according to the threshold sequence-size; and
inputting the organized batch of sequences into the transformer.

2. The computer-implemented method of claim 1, wherein the transformer includes a Bidirectional Encoder Representations from Transformers (BERT) transformer.

3. The computer-implemented method of claim 1, wherein the transformer includes a Generative Pre-trained Transformer (GPT).

4. The computer-implemented method of claim 1, wherein the transformer includes one or more vector matrix multipliers (VMMs).

5. The computer-implemented method of claim 1, wherein the transformer includes one or more attention-compute blocks.

6. The computer-implemented method of claim 1, wherein the transformer includes multiple layers, where each layer includes a VMM block and attention-compute blocks.

7. The computer-implemented method of claim 1, wherein each sequence of the batch of sequences includes a series of words.

8. The computer-implemented method of claim 1, wherein the threshold sequence-size indicates a representative length of a sequence that is input into the transformer, which can be compared to the length of each sequence that is input into the transformer.

9. The computer-implemented method of claim 1, wherein:
the threshold sequence-size results in a first compute time for a sequence by each of one or more vector matrix multipliers (VMMs) of the transformer,
the threshold sequence-size results in a second compute time for the sequence by each of one or more attention-compute blocks of the transformer, and
the first compute time equals the second compute time for the threshold sequence-size.

10. The computer-implemented method of claim 1, wherein organizing the batch of sequences includes:
comparing a length of each sequence of the batch of sequences to the threshold sequence-size; and
arranging the sequences within the batch of sequences in an alternating order based on the comparison.

11. The computer-implemented method of claim 1, wherein the batch of sequences is input into the transformer in an alternating order determined utilizing the threshold sequence-size.

12. The computer-implemented method of claim 1, wherein organizing the batch of sequences includes:
comparing a length of each sequence of the batch of sequences to the threshold sequence-size; and
arranging the sequences within the batch of sequences in a unidirectional order based on the comparison.

13. A computer program product comprising one or more computer readable storage media, and program instructions collectively stored on the one or more computer readable storage media, the program instructions comprising instructions configured to cause one or more processors to perform a method comprising:
determining, by the one or more processors, a threshold sequence-size for a transformer;
organizing, by the one or more processors, a batch of sequences according to the threshold sequence-size; and
inputting, by the one or more processors, the organized batch of sequences into the transformer.

14. The computer program product of claim 13, wherein the transformer includes a Bidirectional Encoder Representations from Transformers (BERT) transformer.

15. The computer program product of claim 13, wherein the transformer includes a Generative Pre-trained Transformer (GPT).

16. The computer program product of claim 13, wherein the transformer includes one or more vector matrix multipliers (VMMs).

17. The computer program product of claim 13, wherein the transformer includes one or more attention-compute blocks.

18. The computer program product of claim 13, wherein the transformer includes multiple layers, where each layer includes a VMM block and attention-compute blocks.

19. The computer program product of claim 13, wherein each sequence of the batch of sequences includes a series of words.

20. A system, comprising:
a processor; and
logic integrated with the processor, executable by the processor, or integrated with and executable by the processor, the logic being configured to:
determine a threshold sequence-size for a transformer;
organize a batch of sequences according to the threshold sequence-size; and
input the organized batch of sequences into the transformer.
